(19) United States
(12) Patent Application Publication
(10) Pub. No.: US 2015/0210565 A1
(43) Pub. Date: Jul. 30, 2015

(54) DE-IONIZATION TREATMENT DEVICE AND METHOD FOR OPERATING DE-IONIZATION TREATMENT DEVICE

(71) Applicants: Kazuhide Kamimura, Hyogo (JP); Hozumi Otozai, Hyogo (JP); Takeshi Terazaki, Hyogo (JP); Hideo Suzuki, Tokyo (JP); Hiroshi Nakashoji, Tokyo (JP)

(72) Inventors: Kazuhide Kamimura, Hyogo (JP); Hozumi Otozai, Hyogo (JP); Takeshi Terazaki, Hyogo (JP); Hideo Suzuki, Tokyo (JP); Hiroshi Nakashoji, Tokyo (JP)

(73) Assignees: MITSUBISHI HEAVY INDUSTRIES MECHATRONICS SYSTEMS., LTD, Kobe-shi, Hyogo (JP); MITSUBISHI HEAVY INDUSTRIES, LTD., Tokyo (JP)

(21) Appl. No.: 14/418,851

(22) PCT Filed: Aug. 3, 2012
(86) PCT No.: PCT/JP2012/069874

§ 371 Date: Jan. 30, 2015

(51) Int. Cl. C02F 1/469; B01D 17/06

(52) U.S. Cl. CPC C02F 1/4691; B01D 17/06; C02F 2103/007

(57) ABSTRACT

A de-ionization treatment device includes a capacitive de-ionization treatment unit. In a de-ionization step before a regeneration step, the de-ionization treatment device injects a scale inhibiting agent into supplied water for a period of time that is deduced from a retained water amount of a de-ionization unit and a supplied water flow rate until a predetermined period of time passes or a predetermined ion concentration is reached. The de-ionization treatment device injects the scale inhibiting agent into supplied water at the time of stoppage of the capacitive de-ionization treatment unit until a predetermined period of time passes or a predetermined ion concentration is reached. Alternatively, at the time of stoppage of the capacitive de-ionization treatment unit, the de-ionization treatment device feeds a low ion concentration water in an amount based on the retained water amount of the de-ionization unit to the capacitive de-ionization treatment unit.

### RELATED APPLICATIONS

The present application is a National Phase of International Application Number PCT/JP2012/069874, filed Aug. 3, 2012.

### TECHNICAL FIELD

The present invention relates to a de-ionization treatment device and a method for operating the same.

### BACKGROUND ART

On the industrial waste water discharged from plants, a purification treatment such as removal of heavy metal components, floating particles, and the like and decomposition removal of organic substances by microorganisms is carried out. In a place where it is difficult to obtain industrial water with certainty, the treated water subjected to the purification treatment is re-used as industrial water. In this case, a de-ionization treatment of removing ion components contained in the discharged water is carried out after the heavy metal components, floating particles, organic substances, and the like are removed.

Also, in using river water or underground water, a de-ionization treatment of removing ion components contained in the water is carried out when the salt components are large in amount to give an obstacle.

As a de-ionization treatment device, a reverse osmosis membrane type demineralizer, a capacitive de-ionization treatment device (for example, Patent Literature 1), and the like are known in the art.

A reverse osmosis membrane type demineralizer has a reverse osmosis membrane (RO membrane) in the inside. When water containing ions flows into the reverse osmosis membrane type demineralizer, the reverse osmosis membrane (RO membrane) allows only water to permeate therethrough. The water (treated water) that has been permeated through the reverse osmosis membrane is re-used as industrial water or the like. On the upstream side of the reverse osmosis membrane, the ions that have failed to pass through the reverse osmosis membrane are concentrated to give concentrated water. This concentrated water is discharged from the system of the water treatment device 1 by being discharged from the reverse osmosis membrane type demineralizer. When the ratio of the treated water relative to the water that flows in is raised, the scale component concentration in the concentrated water becomes larger than the saturation solubility, thereby generating a scale.

In the capacitive de-ionization treatment device disclosed in Patent Literature 1, voltages having opposite polarities with each other are applied between a pair of electrodes. When liquid to be treated passes between the electrodes in this state, the ion components are adsorbed onto the electrodes (de-ionization step). When the electrodes are short-circuited or voltages opposite to those of the ion adsorption time are applied in a state in which the ion adsorption performance of the electrodes has come close to a saturation state, the adsorbed ion components are eliminated from the electrodes. Simultaneously with the elimination of ion components or after the elimination, the liquid to be treated or liquid having a lower ion concentration than the liquid to be treated is passed between the electrodes to remove ions from between the electrodes, whereby the ion components are discharged (component collection step (regeneration step)). Thereafter, the de-ionization step and the regeneration step are repeated to obtain treated water (de-ionized water).

The water to be treated (discharged water, river water, underground water, or the like) contains calcium carbonate (CaCO₃), gypsum (CaSO₄), and calcium fluoride (CaF₂) as salt components. When the concentration of these exceeds the saturation solubility, these are deposited as a crystalline solid component (scale). For example, when 275 mg/l of calcium carbonate is contained at pH 7.3, the scale is deposited because the concentration exceeds the saturation solubility. However, the scale is not deposited even when 10 minutes have passed after preparation of this solution, and the scale is deposited when one day has passed.

In the reverse osmosis membrane type demineralizer, the ion components are continuously removed by the membrane, so that, in an operation with a high water collection ratio, the ion concentration on the concentrated water side is always high, and the concentrated water is kept to have a concentration above or equal to the saturation solubility for a long period of time (one day or more), thereby leading to deposition of the scale.

On the other hand, in the capacitive de-ionization treatment device, concentrated water is present between the electrodes due to elimination of ions from the electrodes in the regeneration step. When the regeneration step is finished within 10 minutes, the de-ionization step starts before the scale deposition. By the start of the de-ionization step, the ion concentration in the water between the electrodes becomes lower than the saturation solubility, so that the scale deposition is inhibited. Owing to this property, the capacitive de-ionization treatment device such as disclosed in Patent Literature 1 is advantageous in that a higher water collection ratio (collection ratio of re-usable water) can be obtained as compared with the reverse osmosis membrane type demineralizer.

### CITATION LIST

### Patent Literature

{PTL 1} the Publication of Japanese Patent No. 4090635 (claims, paragraphs {0019} to {0023})

### SUMMARY OF INVENTION

### Technical Problem

When the ratio of the treated water (de-ionized water) relative to the amount of water supplied to the capacitive de-ionization treatment device is raised, almost all of the ions contained in the supplied water will be contained in the concentrated water, thereby raising the ion concentration of the concentrated water. When the ion concentration exceeds the saturation solubility, the scale is generated in a shorter period of time according as the ion concentration is higher. For example, with respect to an aqueous solution with pH 6.2 and having a fluorine concentration of 18.5 mg/l and a calcium concentration of 675 mg/l, the scale is deposited after one day has passed, though not after 10 minutes have passed. However, with respect to an aqueous solution with pH 6.2 and having a fluorine concentration of 37 mg/l and a calcium concentration of 1350 mg/l, the scale is deposited within 10 minutes.

Also, in the water treatment carried out by the capacitive de-ionization treatment device described above, the concentration of various ions in the concentrated water decreases, in average, to be lower than the saturation solubility at the time point when the regeneration step is ended; however, due to concentration unevenness, there are sites where the concentration still exceeds the saturation solubility in the inside of the de-ionization treatment device. Normally, the de-ionization step is re-started immediately after the regeneration step is ended, so that the sites where the concentration exceeds the saturation solubility return immediately to a state of having a concentration lower than the saturation solubility by the start of the de-ionization step. However, when the amount of water supplied to the capacitive de-ionization treatment device is below or equal to a prescribed value or when the amount of treated water reaches a prescribed value to eliminate the needs for producing the treated water any more, the de-ionization step is not re-started. In such cases, the concentrated water having an ion concentration exceeding the saturation solubility stays between the electrodes for a long period of time, whereby the scale is deposited.

The inside flow path (flow passageway) of the capacitive de-ionization treatment device is clogged by the deposited scale, so that the water to be treated cannot pass at a predetermined flow rate. For this reason, it is demanded that the scale is not deposited even when a concentrated water having highly concentrated ions is generated.

An object of the present invention lies in that, in a de-ionization treatment device having a capacitive de-ionization treatment device, deposition of scale within the capacitive de-ionization treatment device is inhibited with certainty.

### Solution to Problem

A first aspect of the present invention is directed to a de-ionization treatment device including a de-ionization unit provided with a capacitive de-ionization treatment unit having a pair of opposing electrodes that are charged to have opposite polarities with each other, a flow passageway that is located between the electrodes and enables passage of supplied water containing ions, and an ion-exchange membrane disposed on a flow passageway side of each of said electrodes; an injection unit connected to a pipe through which said supplied water passes on an upstream side of said capacitive de-ionization treatment unit, for injecting a scale inhibiting agent into said supplied water; and a controlling unit, wherein said controlling unit includes at least one of a regeneration-time controlling unit that starts injection of said scale inhibiting agent from said injection unit for a period of time that is determined on the basis of a retained water amount of said de-ionization unit and a flow rate of said supplied water while de-ionization is carried out in said capacitive de-ionization treatment unit, and stops injection of said scale inhibiting agent from said injection unit when a predetermined period of time passes after the start of injection of said scale inhibiting agent or when a concentration of said ions in said supplied water discharged from said capacitive de-ionization treatment unit reaches a predetermined amount, and a stoppage-time controlling unit that allows injection of a predetermined amount of said scale inhibiting agent from said injection unit at the time of stoppage of said capacitive de-ionization treatment unit and stops injection of said scale inhibiting agent from said injection unit when a predetermined period of time passes after the start of injection of said scale inhibiting agent at the time of the stoppage of said capacitive de-ionization treatment unit.

A second aspect of the present invention is directed to a method for operating a de-ionization treatment device of the first aspect, including a de-ionization step of allowing supplied water containing ions to pass between a pair of opposing electrodes in a state in which one electrode is charged to be positive and the other electrode is charged to be negative, so as to allow negative ions to be adsorbed onto said one electrode and to allow positive ions to be adsorbed onto said other electrode, thereby to remove said ions from said supplied water; a regeneration step of allowing said supplied water to pass between said electrodes in a state in which said one electrode is charged to be negative and said other electrode is charged to be positive, so as to eliminate said negative ions from said one electrode to release said negative ions into said supplied water and to eliminate said positive ions from said other electrode to release said positive ions into said supplied water, thereby to regenerate said electrodes; and an addition step of adding a scale inhibiting agent into said supplied water, wherein said addition step includes at least one of a regeneration-time addition step and a stoppage-time addition step, said regeneration-time addition step includes a first injection step of injecting said scale inhibiting agent into said supplied water for a period of time that is determined on the basis of a retained water amount of said de-ionization unit and a flow rate of said supplied water during said de-ionization step, and a first injection stoppage step of stopping the injection of said scale inhibiting agent when a predetermined period of time passes after the start of said first injection step or when a concentration of said ions in said supplied water discharged from said capacitive de-ionization treatment unit reaches a predetermined amount, and said stoppage-time addition step includes a second injection step of allowing injection of a predetermined amount of said scale inhibiting agent from said injection unit at the time of stoppage of said capacitive de-ionization treatment unit, and a second injection stoppage step of stopping injection of said scale inhibiting agent from said injection unit when a predetermined period of time passes after the start of said second injection step.

In the above aspects, the period of time for injecting the scale inhibiting agent during the de-ionization step is determined on the basis of the retained water amount of the capacitive de-ionization treatment unit and the supplied water flow rate. By injecting the scale inhibiting agent into the supplied water during the de-ionization step, deposition of scale from the concentrated water in the capacitive de-ionization treatment unit in the regeneration step subsequent to the de-ionization step can be inhibited. Also, in the above aspects, by injecting the scale inhibiting agent when the capacitive de-ionization treatment unit is stopped, scale deposition caused by long-term continuance of the state in which the concentration locally exceeds the saturation solubility can be inhibited.

Further, in the above aspects, injection of the scale inhibiting agent is stopped when the ion concentration in the capacitive de-ionization treatment unit decreases, so that the amount of use of the scale inhibiting agent can be reduced, leading to reduction of the operation costs.

A third aspect of the present invention is directed to a de-ionization treatment device including a de-ionization unit provided with a capacitive de-ionization treatment unit having a pair of opposing electrodes that are charged to have opposite polarities with each other, a flow passageway that is located between the electrodes and enables passage of supplied water containing ions, and an ion-exchange membrane disposed on a flow passageway side of each of said electrodes; a low ion concentration water supplying unit connected to a pipe through which said supplied water passes on an upstream side of said capacitive de-ionization treatment unit, for feeding a low ion concentration water having a lower ion concentration than said supplied water to said capacitive de-ionization treatment unit; and a controlling unit, wherein said controlling unit includes a stoppage-time controlling unit that feeds said low ion concentration water in an amount based on the retained water amount of said de-ionization unit to said capacitive de-ionization treatment unit after said capacitive de-ionization treatment unit is stopped.

A fourth aspect of the present invention is directed to a method for operating a de-ionization treatment device of the third aspect, including a de-ionization step of allowing supplied water containing ions to pass between a pair of opposing electrodes in a state in which one electrode is charged to be positive and the other electrode is charged to be negative, so as to allow negative ions to be adsorbed onto said one electrode and to allow positive ions to be adsorbed onto said other electrode, thereby to remove said ions from said supplied water; a regeneration step of allowing said supplied water to pass between said electrodes in a state in which said one electrode is charged to be negative and said other electrode is charged to be positive, so as to eliminate said negative ions from said one electrode to release said negative ions into said supplied water and to eliminate said positive ions from said other electrode to release said positive ions into said supplied water, thereby to regenerate said electrodes; and a low ion concentration water feeding step of feeding said low ion concentration water in an amount based on the retained water amount of said de-ionization unit to said capacitive de-ionization treatment unit after said capacitive de-ionization treatment unit is stopped.

In the above aspects, the concentrated water in the capacitive de-ionization treatment unit is replaced with the low ion concentration water at the time of stoppage of the capacitive de-ionization treatment unit, so that the ion concentration in the capacitive de-ionization treatment unit becomes lower than the saturation concentration. As a result of this, deposition of scale is inhibited. Also, in the above aspects, there is no need to discharge the scale inhibiting agent or the like in the capacitive de-ionization treatment unit at the time of restarting, so that the restarting can be advantageously carried out quickly.

A fifth aspect of the present invention is directed to a de-ionization treatment device including a de-ionization unit provided with a capacitive de-ionization treatment unit having a pair of opposing electrodes that are charged to have opposite polarities with each other, a flow passageway that is located between the electrodes and enables passage of supplied water containing ions, and an ion-exchange membrane disposed on a flow passageway side of each of said electrodes; an injection unit connected to a pipe through which said supplied water passes on an upstream side of said capacitive de-ionization treatment unit, for injecting a scale inhibiting agent into said supplied water; a low ion concentration water supplying unit connected to a pipe through which said supplied water passes on an upstream side of said capacitive de-ionization treatment unit, for feeding a low ion concentration water having a lower ion concentration than said supplied water to said capacitive de-ionization treatment unit; and a controlling unit, wherein said controlling unit includes one or both of a regeneration-time controlling unit and a stoppage-time injection unit controlling unit, and a low ion concentration water supplying unit controlling unit, said regeneration-time controlling unit starts injection of said scale inhibiting agent from said injection unit for a period of time that is determined on the basis of a retained water amount of said de-ionization unit and a flow rate of said supplied water while de-ionization is carried out in said capacitive de-ionization treatment unit, and stops injection of said scale inhibiting agent from said injection unit when a predetermined period of time passes after the start of injection of said scale inhibiting agent or when a concentration of said ions in said supplied water discharged from said capacitive de-ionization treatment unit reaches a predetermined amount, said stoppage-time injection unit controlling unit allows injection of a predetermined amount of said scale inhibiting agent from said injection unit at the time of stoppage of said capacitive de-ionization treatment unit and stops injection of said scale inhibiting agent from said injection unit when a predetermined period of time passes after the start of injection of said scale inhibiting agent at the time of the stoppage of said capacitive de-ionization treatment unit, and said low ion concentration water supplying unit controlling unit feeds said low ion concentration water in an amount based on the retained water amount of said de-ionization unit to said capacitive de-ionization treatment unit after said capacitive de-ionization treatment unit is stopped.

A sixth aspect of the present invention is directed to a method for operating a de-ionization treatment device of the fifth aspect, including a de-ionization step of allowing supplied water containing ions to pass between a pair of opposing electrodes in a state in which one electrode is charged to be positive and the other electrode is charged to be negative, so as to allow negative ions to be adsorbed onto said one electrode and to allow positive ions to be adsorbed onto said other electrode, thereby to remove said ions from said supplied water; a regeneration step of allowing said supplied water to pass between said electrodes in a state in which said one electrode is charged to be negative and said other electrode is charged to be positive, so as to eliminate said negative ions from said one electrode to release said negative ions into said supplied water and to eliminate said positive ions from said other electrode to release said positive ions into said supplied water, thereby to regenerate said electrodes; an addition step of adding a scale inhibiting agent into said supplied water; and a low ion concentration water feeding step of feeding said low ion concentration water in an amount based on the retained water amount of said de-ionization unit to said capacitive de-ionization treatment unit after said capacitive de-ionization treatment unit is stopped, wherein said addition step includes at least one of a regeneration-time addition step and a stoppage-time addition step, said regeneration-time addition step includes a first injection step of injecting said scale inhibiting agent into said supplied water for a period of time that is determined on the basis of a retained water amount of said de-ionization unit and a flow rate of said supplied water during said de-ionization step, and a first injection stoppage step of stopping the injection of said scale inhibiting agent when a predetermined period of time passes after the start of said first injection step or when a concentration of said ions in said supplied water discharged from said capacitive de-ionization treatment unit reaches a predetermined amount, and said stoppage-time addition step includes a second injection step of allowing injection of a predetermined amount of said scale inhibiting agent from said injection unit at the time of stoppage of said capacitive de-ionization treatment unit, and a second injection stoppage step of stopping injection of said scale inhibiting agent from said injection unit when a predetermined period of time passes after the start of said second injection step.

In the above aspects, the period of time for injecting the scale inhibiting agent during the de-ionization step is determined on the basis of the retained water amount of the capacitive de-ionization treatment unit and the supplied water flow rate. By injecting the scale inhibiting agent into the supplied water during the de-ionization step, deposition of scale from the concentrated water in the capacitive de-ionization treatment unit in the regeneration step can be inhibited, and also the amount of use of the scale inhibiting agent can be reduced. Further, the concentrated water in the capacitive de-ionization treatment unit is replaced with the low ion concentration water at the time of stoppage of the capacitive de-ionization treatment unit, so that the ion concentration in the capacitive de-ionization treatment unit becomes lower than the saturation concentration, whereby deposition of scale is inhibited.

Also, in the above aspects, because the scale inhibiting agent is not injected into the supplied water at the time of stoppage, there is no need to discharge the scale inhibiting agent or the like in the capacitive de-ionization treatment unit at the time of restarting, so that the restarting can be carried out quickly.

In the first aspect or the fifth aspect, it is preferable that the period of time during which said scale inhibiting agent is injected while de-ionization is carried out in said capacitive de-ionization treatment unit is set to be a period of time corresponding to an amount within a range of 0 times to 3 times as large as said retained water amount.

In the second aspect or the sixth aspect, it is preferable that the period of time during which said scale inhibiting agent is injected in said de-ionization step is set to be a period of time corresponding to an amount within a range of 0 times to 3 times as large as said retained water amount.

By doing so, a sufficient amount of the scale inhibiting agent is supplied into the capacitive de-ionization treatment unit when the regeneration step is started, so that the scale deposition can be inhibited with certainty. In particular, when the scale inhibiting agent is injected for a period of time corresponding to an amount of 0 to 1 time as large as the retained water amount, it is more preferable because mingling of a large amount of the scale inhibiting agent into the treated water can be inhibited while suppressing the scale deposition.

In the third aspect or the fifth aspect, it is preferable that the amount of said low ion concentration water fed to said capacitive de-ionization treatment unit is set to be an amount corresponding to 3 times or more as large as said retained water amount.

In the fourth aspect or the sixth aspect, it is preferable that said low ion concentration water is fed in an amount corresponding to 3 times or more as large as said retained water amount.

By doing so, the concentrated water in the capacitive de-ionization treatment unit is sufficiently replaced with the low ion concentration water. As a result of this, the ion concentration in the water within the capacitive de-ionization treatment unit becomes lower than the saturation concentration, thereby inhibiting the scale generation.

### Advantageous Effects of Invention

According to the present invention, scale deposition during the regeneration step can be inhibited with certainty because the scale inhibiting agent is injected for a period of time based on consideration of the retained water amount and the supplied water flow rate in the de-ionization step.

Further, according to the present invention, deposition of scale at the time of stoppage can be inhibited with certainty by injecting the scale inhibiting agent or replacing the concentrated water in the capacitive de-ionization treatment unit with the low ion concentration water at the time of stoppage.

### BRIEF DESCRIPTION OF DRAWINGS

FIG. 1 is a block diagram of a de-ionization treatment device.

FIG. 2 is a schematic view of a capacitive de-ionization treatment unit.

FIG. 3 is a schematic view of a de-ionization unit of the first embodiment.

FIG. 4 is a timing chart of a method for operating a de-ionization treatment device of the first embodiment.

FIG. 5 is a schematic view of a de-ionization unit of the second embodiment.

FIG. 6 is a schematic view of a de-ionization unit of the third embodiment.

### DESCRIPTION OF EMBODIMENTS

FIG. 1 shows a block diagram of a de-ionization treatment device. A de-ionization treatment device 1 includes a pre-treatment unit 2, a biological treatment unit 3, and a de-ionization unit 4 in the order from the upstream side.

The pre-treatment unit 2 receives supplied water such as river water or discharged water from plants and removes oily components, heavy metals, floating particles, and the like in the supplied water. When the content of these substances is small, the pre-treatment unit 2 can be omitted.

The biological treatment unit 3 performs a decomposition treatment on organic substances in the supplied water treated in the pre-treatment unit 2 with the help of microorganisms. The biological treatment unit 3 may be a treatment device (MBR: Membrane Bio-Reactor) using the membrane separation activated sludge method, a treatment device (BFR: Bio-Film Reactor) using the biological membrane method, a construction obtained by combination of an aeration tank and a settlement tank, or the like. The biological treatment unit 3 may have a construction obtained by combination of an MBR and a BFR. In the case of a construction obtained by combination of an aeration tank and a settlement tank, a filtration device such as a filter is disposed after the settlement tank in order to prevent clogging in the demineralizer of the de-ionization unit 4. When the amount of organic substances in the supplied water is small, the biological treatment unit 3 can be omitted.

In the MBR, a membrane having holes of about 0.1 μm is immersed into the supplied water in a biological reaction tank. Microorganisms are present in the supplied water in the biological reaction tank, and the microorganisms decompose the organic substances in the supplied water. The microorganisms useful for the sludge treatment in the biological reaction tank have a size of about 0.25 μm at the minimum. Therefore, the supplied water in the biological reaction tank undergoes solid-liquid separation into the supplied water and the microorganisms by the aforesaid membrane, and only the supplied water is discharged from the MBR.

In the BFR, a supporter having a film of microorganisms formed on the surface thereof is disposed in the inside. When the microorganisms on the supporter surface come into contact with the supplied water, the microorganisms perform a decomposition treatment on the organic substances in the supplied water.

In the case of a construction obtained by combination of an MBR and a BFR, the operation of the MBR and the BFR is controlled in accordance with the amount of organic substances (COD) in the supplied water. For example, when the COD in the supplied water is small, only the MBR is operated. When the fluctuation of the COD becomes large, the BFR is operated in parallel with the MBR.

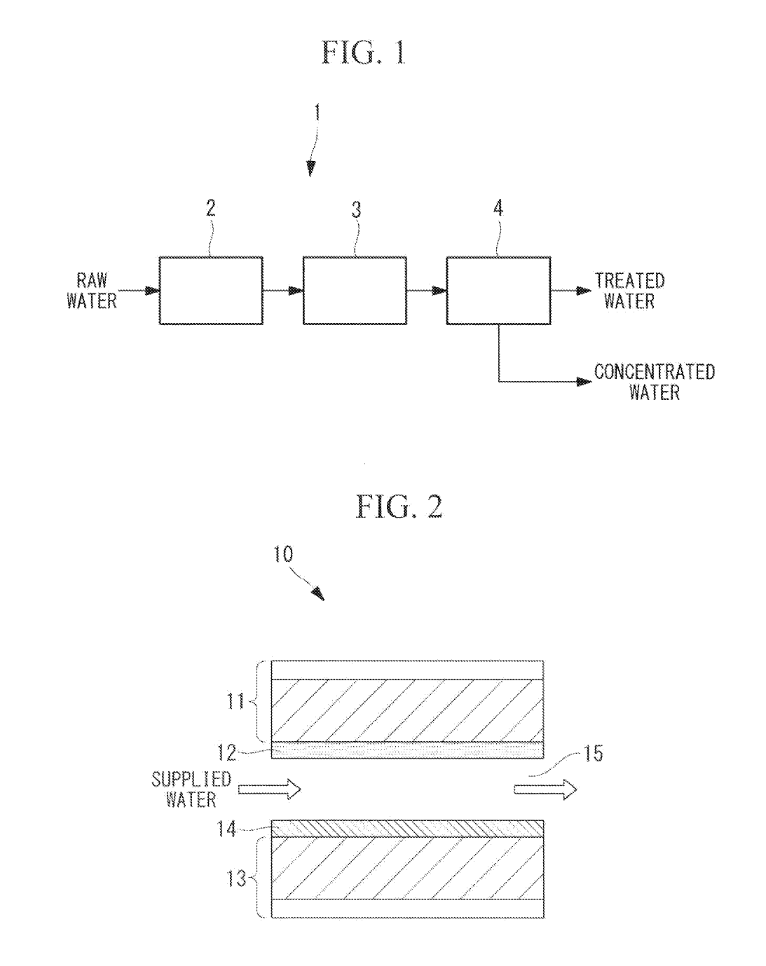

The de-ionization unit 4 includes a capacitive de-ionization treatment unit. FIG. 2 is a schematic view of the capacitive de-ionization treatment unit. The capacitive de-ionization treatment unit 10 includes a pair of opposing porous electrodes 11, 13 and a flow passageway 15 through which the supplied water can pass between the electrodes. An anion-exchange membrane 12 is disposed on a surface on the flow passageway side of the porous electrode 11, and a cation-exchange membrane 14 is disposed on a surface on the flow passageway side of the porous electrode 13.

### First Embodiment

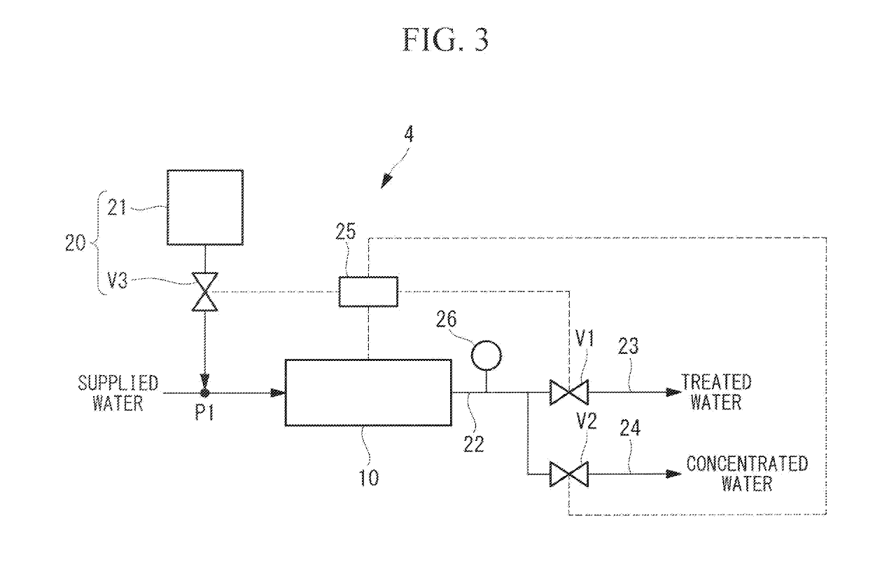

FIG. 3 is a schematic view describing a construction of a de-ionization treatment device of the first embodiment.

The de-ionization treatment device of the first embodiment includes an injection unit 20 on an upstream side of the capacitive de-ionization treatment unit 10, a discharging passageway 22 on a downstream side of the capacitive de-ionization treatment unit 10, and a controlling unit 25.

The discharging passageway 22 is branched in the middle of the passageway into a treated water discharging passageway 23 and a concentrated water discharging passageway 24. Valves V1, V2 are disposed in the treated water discharging passageway 23 and the concentrated water discharging passageway 24, respectively. In FIG. 3, the part between the point P1 and the valves V1, V2 is defined as the de-ionization unit 4.

In FIG. 3, the injection unit 20 is constructed with a tank 21 and a valve V3. Here, the injection unit 20 may have a construction of disposing a pump instead of the valve or a construction of using the pump and the valve in combination. A scale inhibiting agent is stored in the tank 21. The scale inhibiting agent may be a phosphonic acid based scale inhibiting agent (for example, trade name: PC 191 manufactured by Ondeo Nalco Company or trade name: Kimic SI manufactured by Kimic Chemitech(s) PTE LTD).

The injection unit 20 is connected to a pipe through which the supplied water passes on an upstream side of the capacitive de-ionization treatment unit 10. The injection unit 20 is connected at P1 to the pipe through which the supplied water passes. In view of reducing the amount of injection of the scale inhibiting agent, the position of injecting the scale inhibiting agent (position of P1) is preferably in a neighborhood of the capacitive de-ionization treatment unit.

A measurement unit 26 is disposed in the discharging passageway 22. The measurement unit 26 is a unit that measures the electric conductivity of the water discharged from the capacitive de-ionization treatment unit and obtains an ion concentration from the measured electric conductivity.

The controlling unit 25 may be, for example, a computer. The controlling unit 25 is connected to the capacitive de-ionization treatment unit 10 and the valves V1 to V3.

The controlling unit 25 includes a treatment controlling unit. The controlling unit 25 includes one or both of a regeneration-time controlling unit and a stoppage-time controlling unit. The treatment controlling unit performs switching between a de-ionization step and a regeneration step of the capacitive de-ionization treatment unit 10. The regeneration-time controlling unit controls opening and closing of the valve V3 at the time of regeneration of the capacitive de-ionization treatment unit 10. The stoppage-time controlling unit controls opening and closing of the valve V3 at the time of stoppage of the capacitive de-ionization treatment unit 10.

A method for operating the de-ionization treatment device of the first embodiment will be described.

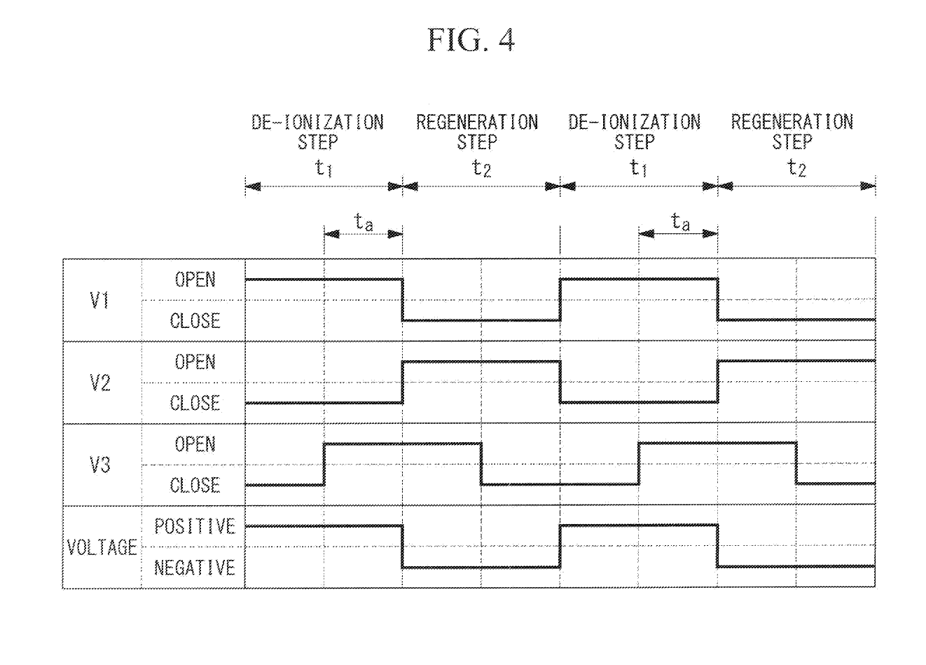

FIG. 4 is a timing chart of the method for operating the de-ionization treatment device of the first embodiment.

### (De-Ionization Step)

The treatment controlling unit of the controlling unit 25 applies a voltage to the electrodes 11, 13 so that the porous electrode 11 is charged to be positive and the porous electrode 13 is charged to be negative. The above-described energization state is referred to as “positive” in FIG. 4. The treatment controlling unit of the controlling unit 25 opens the valve V1 and closes the valve V2.

The supplied water containing ions flows into the capacitive de-ionization treatment unit 10 having the energized porous electrodes 11, 13. When the supplied water passes through the flow passageway 15 between the porous electrodes 11, 13, the negative ions in the supplied water permeate through the anion-exchange membrane 12 to be adsorbed onto the porous electrode 11, and the positive ions in the supplied water permeate through the cation-exchange membrane 14 to be adsorbed onto the porous electrode 13. This allows that the ions are removed from the supplied water.

The supplied water from which the ions have been removed is discharged as treated water from the capacitive de-ionization treatment unit 10 and passes through the treated water discharging passageway 23 so as to be discharged to the outside of the system of the de-ionization treatment device.

### (Regeneration Step)

After the de-ionization step is carried out for a predetermined period of time, the treatment controlling unit of the controlling unit 25 carries out the regeneration step.

The treatment controlling unit of the controlling unit 25 applies a voltage to the electrodes 11, 13 so that the porous electrode 11 is charged to be negative and the porous electrode 13 is charged to be positive. In other words, the treatment controlling unit of the controlling unit 25 turns the electrodes into a reverse energization state. Simultaneously with reversing the energization state of the electrodes 11, 13, the treatment controlling unit of the controlling unit 25 closes the valve V1 and opens the valve V2.

The ions adsorbed in the de-ionization step are eliminated from the porous electrodes 11, 13 and return to the flow passageway 15. The supplied water or clean water (pure water) from a system not illustrated in FIG. 3 is supplied to the flow passageway 15 and discharged from the capacitive de-ionization treatment unit 10 together with the ions released to the flow passageway 15. The water discharged from the capacitive de-ionization treatment unit 10 passes through the concentrated water discharging passageway 24 as concentrated water, so as to be discharged to the outside of the system of the de-ionization treatment device.

The period of time t₁ for performing the de-ionization step and the period of time t₂ for performing the regeneration step are stored in the treatment controlling unit of the controlling unit 25. The values of the periods of time t₁ and t₂ are determined in accordance with the concentration of ions contained in the discharged water and the ion adsorption capacity of the porous electrodes. In order to repeat adsorption and elimination of the ions efficiently, the period of time t₁ for performing the de-ionization step is preferably set to be a value within a range from one minute to 10 minutes, and the period of time t₂ for performing the regeneration step is preferably set to be a value within a range from one minute to five minutes. The treatment controlling unit performs the de-ionization step and the regeneration step for predetermined periods of time based on the stored values of t₁ and t₂.

### (Regeneration-Time Addition Step)

### (First Injection Step)

In the present embodiment, the regeneration controlling unit of the controlling unit 25 opens the value V3 and injects the scale inhibiting agent from the injection unit 20 into the supplied water. It is preferable that a predetermined amount of the scale inhibiting agent is present in the flow passageway of the capacitive de-ionization treatment unit 10 in the regeneration step. From this viewpoint, the first injection step is started in the de-ionization step before the start of the regeneration step and is continued also during the regeneration step.

The period of time during which the regeneration controlling unit opens the value V3 is determined on the basis of the retained water amount of the de-ionization unit 4 and the flow rate of the supplied water passing through the capacitive de-ionization treatment unit 10. The retained water amount of the de-ionization unit 4 is defined as a capacity of the de-ionization unit 4 (the part from P1 to V1, V2).

As a situation of passage of the supplied water, there may be a laminar flow and a turbulent flow. When the supplied water passes mildly to form a laminar flow state, the supplied water that flows into the capacitive de-ionization treatment unit 10 at an arbitrary time passes through the capacitive de-ionization treatment unit 10 while maintaining a constant liquid plane. For this reason, when an amount corresponding to 1 time as large as the retained water amount is let to pass through the capacitive de-ionization treatment unit 10, the water in the capacitive de-ionization treatment unit 10 is replaced in a period of time deduced from the ratio of (retained water amount)/(supplied water flow rate).

When the flow rate of the supplied water reaches a certain region, a turbulent flow state is formed. In the case of a turbulent flow, the supplied water passes while being violently agitated, so that the supplied water is not sufficiently replaced even when an amount corresponding to 1 time as large as the retained water amount is let to flow into the capacitive de-ionization treatment unit 10. In order that the supplied water in the capacitive de-ionization treatment unit 10 be replaced by about 90%, supplied water in an amount corresponding to 3 times as large as the retained water amount must be let to flow into the capacitive de-ionization treatment unit 10.

From the above, in order to let a sufficient amount of the scale inhibiting agent be present in the capacitive de-ionization treatment unit 10 at the time of the start of regeneration, the period of time for starting injection of the scale inhibiting agent into the supplied water is set to be a period of time corresponding to an amount within a range of 1 time to 3 times as large as the retained water amount.

In the present embodiment, it is preferable to prevent mixing of the scale inhibiting agent into the treated water while suppressing scale deposition in the regeneration step.

As described above, in the case of a laminar flow, the water in the capacitive de-ionization treatment unit 10 is replaced in a period of time deduced from the ratio of (retained water amount)/(supplied water flow rate). Therefore, if the scale inhibiting agent is injected into the supplied water at a time point which is prior to the regeneration start time by a period of time corresponding to an amount smaller than one time as large as the retained water amount, the scale inhibiting agent does not reach the valve V1 at the time of closing the valve V1.

In the case of a turbulent flow, if the scale inhibiting agent is injected into the supplied water at a time point which is prior to the regeneration start time by a period of time corresponding to an amount smaller than 0.8 time as large as the retained water amount, the scale inhibiting agent can be prevented from flowing to the downstream side of the valve V1 at the time of closing the valve V1.

From the above, in the present embodiment, the period of time tₐ for injecting the scale inhibiting agent during the de-ionization step is determined by the formula (1).

tₐ=mW/Q (1)

m: coefficient (0≦m≦3)

W: retained water amount (m³)

Q: supplied water flow rate (m³/h)

When the coefficient m is equal to 0 in the formula (1) (at the time of 0 times as large as the retained water amount), tₐ will be 0, indicating that the scale inhibiting agent is injected into the supplied water simultaneously with the end of the de-ionization step (start of the regeneration step).

The period of time tₐ determined from the above is stored in the regeneration time controlling unit of the controlling unit 25. The regeneration time controlling unit determines the time for opening the valve V3 in accordance with the period of time t₁ of the de-ionization step and the period of time tₐ stored in the treatment controlling unit.

The regeneration time controlling unit of the controlling unit 25 opens the valve V3 at the time of opening the valve V3 determined in the above. This allows that the scale inhibiting agent is injected into the supplied water from the injection unit 20.

### (First Injection Stoppage Step)

The time at which the regeneration controlling unit of the controlling unit 25 closes the valve V3 is determined on the basis of the ion concentration in the discharged water (concentrated water) that has passed through the capacitive de-ionization treatment unit 10.

As a method of closing the valve V3 on the basis of the ion concentration, there are a method of determining the time at which the regeneration time controlling unit of the controlling unit 25 closes the valve V3 while monitoring the ion concentration in the concentrated water by the measurement unit 26 and a method of obtaining in advance the period of time until the ion concentration in the concentrated water reaches a predetermined value and allowing the regeneration time controlling unit of the controlling unit 25 to close the valve V3 after the obtained period of time passes.

In the former method, information on the ion concentration in the concentrated water as obtained by the measurement unit 26 is sent to the regeneration time controlling unit of the controlling unit 25. When the ion concentration in the discharged water becomes equal to or lower than the ion concentration that is permitted as treated water, the regeneration time controlling unit of the controlling unit 25 closes the valve V3.

In the latter method, the period of time until the ion concentration in the discharged water becomes equal to or lower than the ion concentration that is permitted as treated water from the time of the start of the regeneration step is obtained on the basis of test results at the time of trial operation of the device, operation data, and the like, and is stored into the regeneration time controlling unit of the controlling unit 25. The regeneration time controlling unit of the controlling unit 25 closes the valve V3 after the above predetermined period of time passes from the time of the start of the regeneration step. This allows that the injection of the scale inhibiting agent from the injection unit 20 into the supplied water is stopped.

### (Stoppage-Time Addition Step)

### (Second Injection Step)

When the amount of water supplied to the capacitive de-ionization treatment device is equal to or lower than a prescribed value or when the amount of treated water reaches a prescribed value, the treatment controlling unit of the controlling unit 25 stops a supplied water pump (not illustrated in the drawings) that supplies supplied water to the capacitive de-ionization treatment unit 10 and the capacitive de-ionization treatment unit 10.

After the capacitive de-ionization treatment is stopped, the stoppage-time controlling unit of the controlling unit 25 closes the valve V1 and opens the valve V2. Simultaneously with this, the stoppage-time controlling unit of the controlling unit 25 opens the valve V3, and the injection unit 20 injects the scale inhibiting agent into the supplied water. When a predetermined period of time passes after the capacitive de-ionization treatment is stopped, the possibility of scale generation becomes high. For this reason, the opening and closing of the valves described above are carried out at a time from the stoppage of the capacitive de-ionization treatment unit 10 until the time when the scale deposition is not generated. The time when the scale deposition is not generated differs depending on the ion concentration in the supplied water and is obtained in advance by a test separately carried out.

### (Second Injection Stoppage Step)

The period of time until the scale inhibiting agent fully reaches the whole of the inside of the capacitive de-ionization treatment unit 10 is obtained in advance by data collection at the time of trial operation or the like. The period of time until the scale inhibiting agent fully reaches the whole of the inside of the capacitive de-ionization treatment unit 10 is stored in the stoppage-time controlling unit of the controlling unit 25.

The stoppage-time controlling unit closes the valve V1 and the valve V3 after the above stored period of time until the scale inhibiting agent fully reaches the whole of the inside of the capacitive de-ionization treatment unit 10 passes from the time point of injection of the scale inhibiting agent.

In the method of operating the de-ionization treatment device according to the present embodiment, either one of the regeneration-time addition step and the stoppage-time addition step may be carried out, or both of the regeneration-time addition step and the stoppage-time addition step may be carried out.

### Second Embodiment

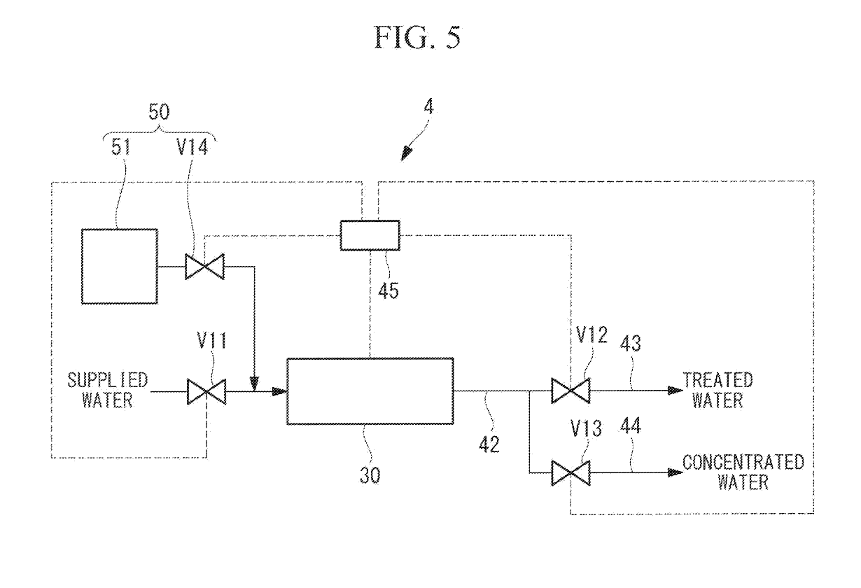

FIG. 5 is a schematic view describing a construction of a de-ionization treatment device of the second embodiment.

The de-ionization treatment device of the second embodiment includes a low ion concentration water supplying unit 50 on an upstream side of the capacitive de-ionization treatment unit 30, a discharging passageway 42 on a downstream side of the capacitive de-ionization treatment unit 30, and a controlling unit 45.

The capacitive de-ionization treatment unit 30 of the second embodiment is made to have the same construction as in FIG. 2.

A valve V11 is disposed on an upstream side of the capacitive de-ionization treatment unit 30. Valves V12, V13 are disposed in the treated water discharging passageway 43 and the concentrated water discharging passageway 44, respectively. In FIG. 5, the part between the valve V11 and the valves V12, V13 is defined as the de-ionization unit 4.

The low ion concentration water supplying unit 50 is connected to a pipe through which the supplied water passes on a downstream side of the valve 11. The low ion concentration water supplying unit 50 is constructed with a tank 51 and a valve V14. Here, the low ion concentration water supplying unit 50 may have a construction of disposing a pump instead of the valve or a construction of using the pump and the valve in combination.

Water (low ion concentration water) having a lower ion concentration than the supplied water is stored in the tank 51. The low ion concentration water is set to be, for example, ion-exchange water, treated water after the capacitive de-ionization treatment, or a permeated water of a reverse osmosis membrane type demineralizer. When the treated water after the capacitive de-ionization treatment is used as the low ion concentration water, a pipe (not illustrated in the drawings) connecting between the treated water discharging passageway 43 and the tank 51 is disposed.

The controlling unit 45 may be, for example, a computer. The controlling unit 45 is connected to the capacitive de-ionization treatment unit 30 and the valves V11 to V14.

The controlling unit 45 includes a treatment controlling unit and a stoppage-time controlling unit. The treatment controlling unit performs switching between a de-ionization step and a regeneration step of the capacitive de-ionization treatment unit 30. The period of time t₁ for carrying out the de-ionization step and the period of time t₂ for carrying out the regeneration step are stored in the treatment controlling unit. The stoppage-time controlling unit controls opening and closing of the valves V11, V12, V13, V14 at the time of stoppage of the capacitive de-ionization treatment unit 30.

A method for operating the de-ionization treatment device of the second embodiment will be described.

### (De-Ionization Step)

At the time of start of the de-ionization step, the treatment controlling unit of the controlling unit 45 opens the valve V11 and closes the valve V14.

In the same manner as in the first embodiment, the treatment controlling unit of the controlling unit 45 applies a voltage to each electrode of the capacitive de-ionization treatment unit 30. The treatment controlling unit of the controlling unit 45 opens the valve V12 and closes the valve V13. This allows that a de-ionization step similar to that of the first embodiment is carried out.

### (Regeneration Step)

In the same manner as in the first embodiment, the treatment controlling unit of the controlling unit 45 applies a reverse voltage, which is opposite to that in the de-ionization step, to each electrode of the capacitive de-ionization treatment unit 30. The treatment controlling unit of the controlling unit 45 closes the valve V12 and opens the valve V13. This allows that a regeneration step similar to that of the first embodiment is carried out.

### (Low Ion Concentration Water Feeding Step)

When the amount of water supplied to the capacitive de-ionization treatment device is below or equal to a prescribed value or when the amount of treated water reaches a prescribed value, the treatment controlling unit of the controlling unit 45 stops the supplied water pump and the capacitive de-ionization treatment unit 30.

After the capacitive de-ionization treatment is stopped, the stoppage-time controlling unit of the controlling unit 45 closes the valves V11, V12 and opens the valves V13, V14. When a predetermined period of time passes after the capacitive de-ionization treatment is stopped, the possibility of scale generation becomes high. For this reason, the opening and closing of the valves described above are carried out at a time from the stoppage of the capacitive de-ionization treatment unit 30 until the time when the scale deposition is not generated. The time when the scale deposition is not generated differs depending on the ion concentration in the supplied water and is obtained in advance by a test separately carried out. By opening of the valve V14, the low ion concentration water supplying unit 50 feeds the low ion concentration water towards the capacitive de-ionization treatment unit 30. The concentrated water having a high ion concentration that stays in the flow passageway between the electrodes of the capacitive de-ionization treatment unit 30 is replaced with the low ion concentration water and is discharged from the capacitive de-ionization treatment unit 30. As a result of this, the ion concentration in the water within the flow passageway decreases, whereby scale deposition is inhibited.

In the present embodiment, in order that the concentrated water in the flow passageway is sufficiently replaced with the low ion concentration water so as to let the ion concentration in the water within the flow passageway be lower than the saturation concentration, the amount of the low ion concentration water supplied from the low ion concentration water supplying unit 50 is preferably 3 times or more as large as the retained water amount of the de-ionization unit 4.

When a predetermined amount of the low ion concentration water is fed from the low ion concentration water supplying unit 50 to the capacitive de-ionization treatment unit 30, the stoppage-time controlling unit of the controlling unit 45 closes the valve V14.

### Third Embodiment

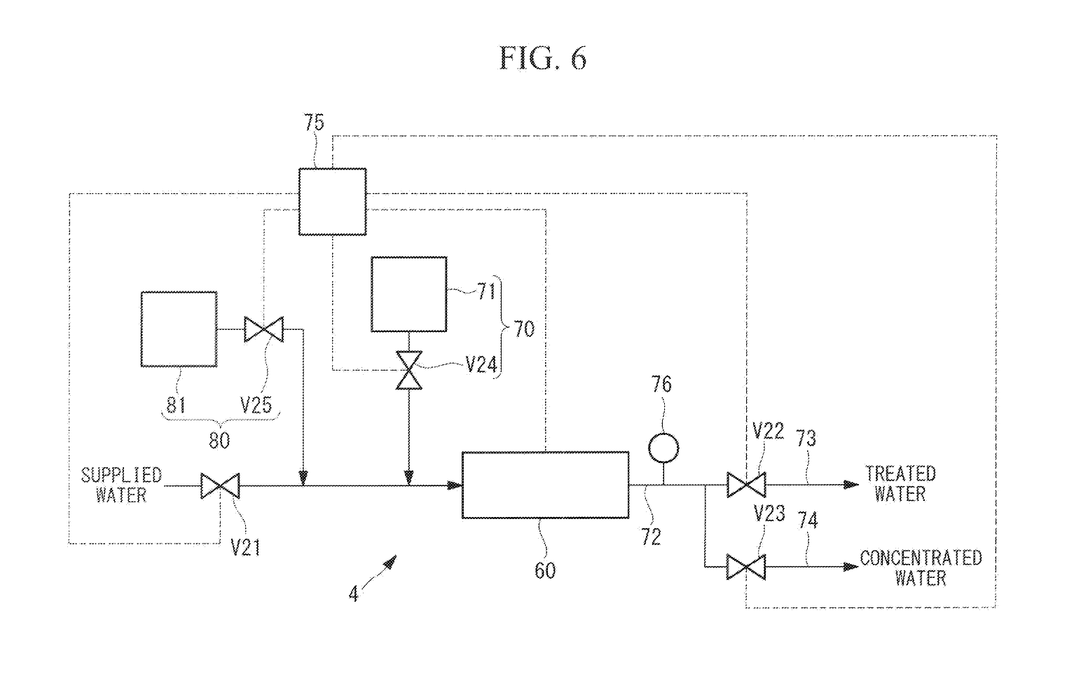

FIG. 6 is a schematic view describing a construction of a de-ionization treatment device of the third embodiment.

The de-ionization treatment device of the third embodiment includes an injection unit 70 and a low ion concentration water supplying unit 80 on an upstream side of the capacitive de-ionization treatment unit 60. Also, the de-ionization treatment device includes a discharging passageway 72 on a downstream side of the capacitive de-ionization treatment unit 60. The discharging passageway 72 is branched in the middle of the passageway into a treated water discharging passageway 73 and a concentrated water discharging passageway 74.

The capacitive de-ionization treatment unit 60 of the third embodiment is made to have the same construction as in FIG. 2.

A valve V21 is disposed on an upstream side of the capacitive de-ionization treatment unit 60. Valves V22, V23 are disposed in the treated water discharging passageway 73 and the concentrated water discharging passageway 74, respectively. The part between the valve V21 and the valves V22, V23 is defined as the de-ionization unit 4.

In the same manner as in the first embodiment, the injection unit 70 is constructed with a tank 71 and a valve V24. The injection unit 70 is connected to a pipe through which the supplied water passes in a neighborhood on an upstream side of the capacitive de-ionization treatment unit 60.

In the same manner as in the second embodiment, the low ion concentration water supplying unit 80 is constructed with a tank 81 and a valve V25. The low ion concentration water supplying unit 80 is connected to a pipe through which the supplied water passes on a downstream side of the valve 21.

The positional relationship of disposing the injection unit 70 and the low ion concentration water supplying unit 80 in the passage direction of the supplied water is not particularly limited; however, the position of connecting the injection unit 70 is preferably close to the capacitive de-ionization treatment unit 60 in view of reducing the amount of injection of the scale inhibiting agent.

A measurement unit 76 is disposed in the discharging passageway 72. In the same manner as in the first embodiment, the measurement unit 76 is a unit that measures the electric conductivity of the discharged water and obtains an ion concentration from the measured electric conductivity.

The controlling unit 75 may be, for example, a computer. The controlling unit 75 is connected to the capacitive de-ionization treatment unit 60 and the valves V21 to V25.

The controlling unit 75 includes a treatment controlling unit, a regeneration-time controlling unit and a stoppage-time controlling unit. The treatment controlling unit performs switching between a de-ionization step and a regeneration step of the capacitive de-ionization treatment unit 60. The period of time t₁ for carrying out the de-ionization step and the period of time t₂ for carrying out the regeneration step are stored in the treatment controlling unit. The regeneration-time controlling unit controls opening and closing of the valve V24 at the time of regeneration of the capacitive de-ionization treatment unit 60. The stoppage-time controlling unit includes a first stoppage-time controlling unit that controls opening and closing of the valves V21, V22, V23, a second stoppage-time controlling unit (stoppage-time injection unit controlling unit) that controls opening and closing of the valve V24, and a third stoppage-time controlling unit (low ion concentration water supplying unit controlling unit) that controls opening and closing of the valve V25 at the time of stoppage of the capacitive de-ionization treatment unit 60. However, in the present embodiment, there are cases in which either one of the regeneration-time controlling unit and the second stoppage-time controlling unit is provided.

A method for operating the de-ionization treatment device of the third embodiment will be described.

### (De-Ionization Step)

At the time of start of the de-ionization step, the controlling unit 75 opens the valve V21 and closes the valves V24, V25.

In the same manner as in the first embodiment, the treatment controlling unit of the controlling unit 75 applies a voltage to each electrode of the capacitive de-ionization treatment unit 60. The treatment controlling unit of the controlling unit 75 opens the valve V22 and closes the valve V23. This allows that a de-ionization step similar to that of the first embodiment is carried out.

### (Regeneration Step)

In the same manner as in the first embodiment, the treatment controlling unit of the controlling unit 75 applies a reverse voltage, which is opposite to that in the de-ionization step, to each electrode of the capacitive de-ionization treatment unit 60. The treatment controlling unit of the controlling unit 75 closes the valve V22 and opens the valve V23. This allows that a regeneration step similar to that of the first embodiment is carried out.

### (Regeneration-Time Addition Step)

### (First Injection Step)

In the present embodiment, the regeneration-time controlling unit of the controlling unit 75 performs control of scale inhibiting agent injection from the injection unit 70 on the basis of the timing chart shown in FIG. 4, in the same manner as in the first embodiment. In other words, the regeneration-time controlling unit of the controlling unit 75 opens the valve V24 so that the scale inhibiting agent is injected during the de-ionization step for the period of time of tₐ that is deduced from the retained water amount and the supplied water flow rate. This allows that the scale inhibiting agent is injected from the injection unit 70 into the supplied water. In the present embodiment as well, in order to let a sufficient amount of the scale inhibiting agent be present in the capacitive de-ionization treatment unit 60 at the time of the start of regeneration, the period of time for starting injection of the scale inhibiting agent into the supplied water is set to be a period of time corresponding to an amount within a range of 0 times to 3 times as large as the retained water amount.

### (First Injection Stoppage Step)

In the same manner as in the first embodiment, the regeneration-time controlling unit of the controlling unit 75 closes the valve V24 when the ion concentration transmitted from the measurement unit 76 to the regeneration-time controlling unit of the controlling unit 75 becomes equal to or lower than a predetermined value. Alternatively, in the same manner as in the first embodiment, the regeneration-time controlling unit of the controlling unit 75 closes the valve V24 after the above predetermined period of time passes from the time of the start of the regeneration step. By closing of the valve V24, the injection of the scale inhibiting agent from the injection unit 70 is stopped.

### (Stoppage-Time Treatment Step)

When the amount of water supplied to the capacitive de-ionization treatment device is equal to or lower than a prescribed value or when the amount of treated water reaches a prescribed value, the treatment controlling unit of the controlling unit 75 stops a supplied water pump (not illustrated in the drawings) that supplies supplied water to the capacitive de-ionization treatment unit 60 and the capacitive de-ionization treatment unit 60.

The stoppage-time treatment step includes a step (second injection step, second injection stoppage step) of performing control of the injection of the scale inhibiting agent and a low ion concentration water feeding step.

After the capacitive de-ionization treatment is stopped, the first stoppage-time controlling unit of the controlling unit 75 closes the valves V21, V22 and opens the valve V23.

### (Stoppage-Time Addition Step)

### (Second Injection Step)

The second stoppage-time controlling unit of the controlling unit 75 opens the valve V24. In the same manner as in the first embodiment, the injection unit 70 injects the scale inhibiting agent into the supplied water. This allows that the inside of the capacitive de-ionization treatment unit 60 is filled with water containing the scale inhibiting agent.

### (Second Injection Stoppage Step)

The period of time until the scale inhibiting agent fully reaches the whole of the inside of the capacitive de-ionization treatment unit 60 is obtained in advance by data collection at the time of trial operation or the like. The period of time until the scale inhibiting agent fully reaches the whole of the inside of the capacitive de-ionization treatment unit 60 is stored in the second stoppage-time controlling unit of the controlling unit 75.

The second stoppage-time controlling unit of the controlling unit 75 closes the valve V24 after the above stored period of time until the scale inhibiting agent fully reaches the whole of the inside of the capacitive de-ionization treatment unit 60 passes from the time point of injection of the scale inhibiting agent (the time point at which the capacitive de-ionization treatment unit 60 is stopped).

### (Low Ion Concentration Water Feeding Step)

The third stoppage-time controlling unit of the controlling unit 75 opens the valve V25. This allows that the low ion concentration water supplying unit 80 feeds the low ion concentration water towards the capacitive de-ionization treatment unit 60 in the same manner as in the second embodiment. The concentrated water having a high ion concentration that stays in the flow passageway of the capacitive de-ionization treatment unit 60 is replaced with the low ion concentration water and is discharged from the capacitive de-ionization treatment unit 60. As a result of this, the ion concentration in the water within the flow passageway decreases.

In the present embodiment as well, the amount of the low ion concentration water supplied from the low ion concentration water supplying unit 80 is preferably 3 times or more as large as the retained water amount of the de-ionization unit 4.

When a predetermined amount of the low ion concentration water is fed from the low ion concentration water supplying unit 80 to the capacitive de-ionization treatment unit 60, the third stoppage-time controlling unit of the controlling unit 75 closes the valve V25.

In the method of operating the discharged water de-ionization treatment device according to the present embodiment, either one of the regeneration-time addition step and the stoppage-time addition step may be carried out, or both of the regeneration-time addition step and the stoppage-time addition step may be carried out.

1-10. (canceled)

11. A de-ionization treatment device comprising:
a de-ionization unit provided with a capacitive de-ionization treatment unit having a pair of opposing electrodes that are charged to have opposite polarities with each other, a flow passageway that is located between the electrodes and enables passage of supplied water containing ions, and an ion-exchange membrane disposed on a flow passageway side of each of said electrodes;
an injection unit connected to a pipe through which said supplied water passes on an upstream side of said capacitive de-ionization treatment unit, for injecting a scale inhibiting agent into said supplied water; and
a controlling unit, wherein
said controlling unit includes at least one of:
a regeneration-time controlling unit that starts injection of said scale inhibiting agent from said injection unit for a period of time that is determined on the basis of a retained water amount of said de-ionization unit and a flow rate of said supplied water while de-ionization is carried out in said capacitive de-ionization treatment unit or simultaneously with the start of regeneration of said capacitive de-ionization treatment unit, and stops injection of said scale inhibiting agent from said injection unit when a predetermined period of time passes after the start of injection of said scale inhibiting agent or when a concentration of said ions in said supplied water discharged from said capacitive de-ionization treatment unit reaches a predetermined amount.

12. A de-ionization treatment device comprising:
a de-ionization unit provided with a capacitive de-ionization treatment unit having a pair of opposing electrodes that are charged to have opposite polarities with each other, a flow passageway that is located between the electrodes and enables passage of supplied water containing ions, and an ion-exchange membrane disposed on a flow passageway side of each of said electrodes;
an injection unit connected to a pipe through which said supplied water passes on an upstream side of said capacitive de-ionization treatment unit, for injecting a scale inhibiting agent into said supplied water; and
a controlling unit, wherein
said controlling unit includes a stoppage-time controlling unit that allows injection of a predetermined amount of said scale inhibiting agent from said injection unit at the time of stoppage of said capacitive de-ionization treatment unit and stops injection of said scale inhibiting agent from said injection unit when a predetermined period of time passes after the start of injection of said scale inhibiting agent at the time of the stoppage of said capacitive de-ionization treatment unit.

13. A de-ionization treatment device comprising:
a de-ionization unit provided with a capacitive de-ionization treatment unit having a pair of opposing electrodes that are charged to have opposite polarities with each other, a flow passageway that is located between the electrodes and enables passage of supplied water containing ions, and an ion-exchange membrane disposed on a flow passageway side of each of said electrodes;
an injection unit connected to a pipe through which said supplied water passes on an upstream side of said capacitive de-ionization treatment unit, for injecting a scale inhibiting agent into said supplied water; and
a controlling unit, wherein
said controlling unit includes at least one of:
a regeneration-time controlling unit that starts injection of said scale inhibiting agent from said injection unit for a period of time that is determined on the basis of a retained water amount of said de-ionization unit and a flow rate of said supplied water while de-ionization is carried out in said capacitive de-ionization treatment unit or simultaneously with the start of regeneration of said capacitive de-ionization treatment unit, and stops injection of said scale inhibiting agent from said injection unit when a predetermined period of time passes after the start of injection of said scale inhibiting agent or when a concentration of said ions in said supplied water discharged from said capacitive de-ionization treatment unit reaches a predetermined amount, and
a stoppage-time controlling unit that allows injection of a predetermined amount of said scale inhibiting agent from said injection unit at the time of stoppage of said capacitive de-ionization treatment unit and stops injection of said scale inhibiting agent from said injection unit when a predetermined period of time passes after the start of injection of said scale inhibiting agent at the time of the stoppage of said capacitive de-ionization treatment unit.

14. A de-ionization treatment device comprising:
a de-ionization unit provided with a capacitive de-ionization treatment unit having a pair of opposing electrodes that are charged to have opposite polarities with each other, a flow passageway that is located between the electrodes and enables passage of supplied water containing ions, and an ion-exchange membrane disposed on a flow passageway side of each of said electrodes;
a low ion concentration water supplying unit connected to a pipe through which said supplied water passes on an upstream side of said capacitive de-ionization treatment unit, for feeding a low ion concentration water having a lower ion concentration than said supplied water to said capacitive de-ionization treatment unit; and
a controlling unit, wherein
said controlling unit includes a stoppage-time controlling unit that feeds said low ion concentration water in an amount based on the retained water amount of said de-ionization unit to said capacitive de-ionization treatment unit after the stop of said capacitive de-ionization treatment unit.

15. A de-ionization treatment device comprising:
a de-ionization unit provided with a capacitive de-ionization treatment unit having a pair of opposing electrodes that are charged to have opposite polarities with each other, a flow passageway that is located between the electrodes and enables passage of supplied water containing ions, and an ion-exchange membrane disposed on a flow passageway side of each of said electrodes;
an injection unit connected to a pipe through which said supplied water passes on an upstream side of said capacitive de-ionization treatment unit, for injecting a scale inhibiting agent into said supplied water;
a low ion concentration water supplying unit connected to a pipe through which said supplied water passes on an upstream side of said capacitive de-ionization treatment unit, for feeding a low ion concentration water having a lower ion concentration than said supplied water to said capacitive de-ionization treatment unit; and
a controlling unit, wherein
said controlling unit includes one or both of a regeneration-time controlling unit and a stoppage-time injection unit controlling unit, and a low ion concentration water supplying unit controlling unit,
said regeneration-time controlling unit starts injection of said scale inhibiting agent from said injection unit for a period of time that is determined on the basis of a retained water amount of said de-ionization unit and a flow rate of said supplied water while de-ionization is carried out in said capacitive de-ionization treatment unit or simultaneously with the start of regeneration of said capacitive de-ionization treatment unit, and stops injection of said scale inhibiting agent from said injection unit when a predetermined period of time passes after the start of injection of said scale inhibiting agent or when a concentration of said ions in said supplied water discharged from said capacitive de-ionization treatment unit reaches a predetermined amount,
said stoppage-time injection unit controlling unit allows injection of a predetermined amount of said scale inhibiting agent from said injection unit at the time of stoppage of said capacitive de-ionization treatment unit and stops injection of said scale inhibiting agent from said injection unit when a predetermined period of time passes after the start of injection of said scale inhibiting agent at the time of the stoppage of said capacitive de-ionization treatment unit, and
said low ion concentration water supplying unit controlling unit feeds said low ion concentration water in an amount based on the retained water amount of said de-ionization unit to said capacitive de-ionization treatment unit after said capacitive de-ionization treatment unit is stopped.

16. The de-ionization treatment device according to claim 11, wherein the period of time during which said scale inhibiting agent is injected while de-ionization is carried out in said capacitive de-ionization treatment unit is set to be a period of time corresponding to an amount within a range of 0 times to 3 times as large as said retained water amount.

17. The de-ionization treatment device according to claim 14, wherein the amount of said low ion concentration water fed to said capacitive de-ionization treatment unit is set to be an amount corresponding to 3 times or more as large as said retained water amount.

18. A method for operating a de-ionization treatment device according to claim 11, comprising:
a de-ionization step of allowing supplied water containing ions to pass between a pair of opposing electrodes in a state in which one electrode is charged to be positive and the other electrode is charged to be negative, so as to allow negative ions to be adsorbed onto said one electrode and to allow positive ions to be adsorbed onto said other electrode, thereby to remove said ions from said supplied water;
a regeneration step of allowing said supplied water to pass between said electrodes in a state in which said one electrode is charged to be negative and said other electrode is charged to be positive, so as to eliminate said negative ions from said one electrode to release said negative ions into said supplied water and to eliminate said positive ions from said other electrode to release said positive ions into said supplied water, thereby to regenerate said electrodes; and
a regeneration-time addition step, wherein
said regeneration-time addition step includes:
a first injection step of injecting said scale inhibiting agent into said supplied water for a period of time that is determined on the basis of a retained water amount of said de-ionization unit and a flow rate of said supplied water during said de-ionization step or simultaneously with the start of said regeneration step, and
a first injection stoppage step of stopping the injection of said scale inhibiting agent when a predetermined period of time passes after the start of said first injection step or when a concentration of said ions in said supplied water discharged from said capacitive de-ionization treatment unit reaches a predetermined amount.

19. A method for operating a de-ionization treatment device according to claim 12, comprising:
a de-ionization step of allowing supplied water containing ions to pass between a pair of opposing electrodes in a state in which one electrode is charged to be positive and the other electrode is charged to be negative, so as to allow negative ions to be adsorbed onto said one electrode and to allow positive ions to be adsorbed onto said other electrode, thereby to remove said ions from said supplied water;
a regeneration step of allowing said supplied water to pass between said electrodes in a state in which said one electrode is charged to be negative and said other electrode is charged to be positive, so as to eliminate said negative ions from said one electrode to release said negative ions into said supplied water and to eliminate said positive ions from said other electrode to release said positive ions into said supplied water, thereby to regenerate said electrodes; and
a stoppage-time addition step, wherein
said stoppage-time addition step includes:
a second injection step of allowing injection of a predetermined amount of said scale inhibiting agent from said injection unit at the time of stoppage of said capacitive de-ionization treatment unit, and
a second injection stoppage step of stopping injection of said scale inhibiting agent from said injection unit when a predetermined period of time passes after the start of said second injection step.

20. A method for operating a de-ionization treatment device according to claim 13, comprising:
a de-ionization step of allowing supplied water containing ions to pass between a pair of opposing electrodes in a state in which one electrode is charged to be positive and the other electrode is charged to be negative, so as to allow negative ions to be adsorbed onto said one electrode and to allow positive ions to be adsorbed onto said other electrode, thereby to remove said ions from said supplied water;
a regeneration step of allowing said supplied water to pass between said electrodes in a state in which said one electrode is charged to be negative and said other electrode is charged to be positive, so as to eliminate said negative ions from said one electrode to release said negative ions into said supplied water and to eliminate said positive ions from said other electrode to release said positive ions into said supplied water, thereby to regenerate said electrodes; and
an addition step of adding a scale inhibiting agent into said supplied water, wherein
said addition step includes at least one of a regeneration-time addition step and a stoppage-time addition step,
said regeneration-time addition step includes:
a first injection step of injecting said scale inhibiting agent into said supplied water for a period of time that is determined on the basis of a retained water amount of said de-ionization unit and a flow rate of said supplied water during said de-ionization step or simultaneously with the start of said regeneration step, and
a first injection stoppage step of stopping the injection of said scale inhibiting agent when a predetermined period of time passes after the start of said first injection step or when a concentration of said ions in said supplied water discharged from said capacitive de-ionization treatment unit reaches a predetermined amount, and
said stoppage-time addition step includes:
a second injection step of allowing injection of a predetermined amount of said scale inhibiting agent from said injection unit at the time of stoppage of said capacitive de-ionization treatment unit, and
a second injection stoppage step of stopping injection of said scale inhibiting agent from said injection unit when a predetermined period of time passes after the start of said second injection step.

21. A method for operating a de-ionization treatment device according to claim 14, comprising:
a de-ionization step of allowing supplied water containing ions to pass between a pair of opposing electrodes in a state in which one electrode is charged to be positive and the other electrode is charged to be negative, so as to allow negative ions to be adsorbed onto said one electrode and to allow positive ions to be adsorbed onto said other electrode, thereby to remove said ions from said supplied water;
a regeneration step of allowing said supplied water to pass between said electrodes in a state in which said one electrode is charged to be negative and said other electrode is charged to be positive, so as to eliminate said negative ions from said one electrode to release said negative ions into said supplied water and to eliminate said positive ions from said other electrode to release said positive ions into said supplied water, thereby to regenerate said electrodes; and
a low ion concentration water feeding step of feeding said low ion concentration water in an amount based on the retained water amount of said de-ionization unit to said capacitive de-ionization treatment unit after the stop of said capacitive de-ionization treatment unit.

22. A method for operating a de-ionization treatment device according to claim 15, comprising:
a de-ionization step of allowing supplied water containing ions to pass between a pair of opposing electrodes in a state in which one electrode is charged to be positive and the other electrode is charged to be negative, so as to allow negative ions to be adsorbed onto said one electrode and to allow positive ions to be adsorbed onto said other electrode, thereby to remove said ions from said supplied water;
a regeneration step of allowing said supplied water to pass between said electrodes in a state in which said one electrode is charged to be negative and said other electrode is charged to be positive, so as to eliminate said negative ions from said one electrode to release said negative ions into said supplied water and to eliminate said positive ions from said other electrode to release said positive ions into said supplied water, thereby to regenerate said electrodes;
an addition step of adding a scale inhibiting agent into said supplied water; and
a low ion concentration water feeding step of feeding said low ion concentration water in an amount based on the retained water amount of said de-ionization unit to said capacitive de-ionization treatment unit after said capacitive de-ionization treatment unit is stopped, wherein
said addition step includes at least one of a regeneration-time addition step and a stoppage-time addition step,
said regeneration-time addition step includes:
a first injection step of injecting said scale inhibiting agent into said supplied water for a period of time that is determined on the basis of a retained water amount of said de-ionization unit and a flow rate of said supplied water during said de-ionization step or simultaneously with the start of regeneration of said capacitive de-ionization treatment unit, and
a first injection stoppage step of stopping the injection of said scale inhibiting agent when a predetermined period of time passes after the start of said first injection step or when a concentration of said ions in said supplied water discharged from said capacitive de-ionization treatment unit reaches a predetermined amount, and
said stoppage-time addition step includes:
a second injection step of allowing injection of a predetermined amount of said scale inhibiting agent from said injection unit at the time of stoppage of said capacitive de-ionization treatment unit, and
a second injection stoppage step of stopping injection of said scale inhibiting agent from said injection unit when a predetermined period of time passes after the start of said second injection step.

23. The method for operating a de-ionization treatment device according to claim 18, wherein the period of time during which said scale inhibiting agent is injected in said de-ionization step is set to be a period of time corresponding to an amount within a range of 0 times to 3 times as large as said retained water amount.

24. The method for operating a de-ionization treatment device according to claim 21, wherein said low ion concentration water is fed in an amount corresponding to 3 times or more as large as said retained water amount.

25. The de-ionization treatment device according to claim 13, wherein the period of time during which said scale inhibiting agent is injected while de-ionization is carried out in said capacitive de-ionization treatment unit is set to be a period of time corresponding to an amount within a range of 0 times to 3 times as large as said retained water amount.

26. The de-ionization treatment device according to claim 15, wherein the period of time during which said scale inhibiting agent is injected while de-ionization is carried out in said capacitive de-ionization treatment unit is set to be a period of time corresponding to an amount within a range of 0 times to 3 times as large as said retained water amount.

27. The de-ionization treatment device according to claim 15, wherein the amount of said low ion concentration water fed to said capacitive de-ionization treatment unit is set to be an amount corresponding to 3 times or more as large as said retained water amount.

28. The method for operating a de-ionization treatment device according to claim 20, wherein the period of time during which said scale inhibiting agent is injected in said de-ionization step is set to be a period of time corresponding to an amount within a range of 0 times to 3 times as large as said retained water amount.

29. The method for operating a de-ionization treatment device according to claim 22, wherein the period of time during which said scale inhibiting agent is injected in said de-ionization step is set to be a period of time corresponding to an amount within a range of 0 times to 3 times as large as said retained water amount.

30. The method for operating a de-ionization treatment device according to claim 22, wherein said low ion concentration water is fed in an amount corresponding to 3 times or more as large as said retained water amount.
